(19) United States
(12) Patent Application Publication
(10) Pub. No.: US 2016/0019728 A1
(43) Pub. Date: Jan. 21, 2016

(54) Public Booking and Payment System

(71) Applicant: INGOGO PTY LTD, Mascot (AU)

(72) Inventor: Hamish Petrie, Mascot (AU)

(21) Appl. No.: 14/100,376

(22) Filed: Dec. 9, 2013

Related U.S. Application Data
(63) Continuation of application No. PCT/AU2012/000658, filed on Jun. 8, 2012.

(30) Foreign Application Priority Data
Jun. 9, 2011 (AU) 2011902264
Aug. 24, 2011 (AU) 2011903393
Apr. 3, 2012 (AU) 2012901319

(51) Int. Cl. G07B 15/02; G06Q 20/28; G06Q 20/32

(52) U.S. Cl. CPC G07B 15/02; G06Q 20/322; G06Q 20/28

(57) ABSTRACT

A method and a system are disclosed that facilitate booking and payment for taxi cabs and other forms of transport. The system comprises a locator process arranged to obtain the location of a vehicle for hire and an order process arranged to receive a booking order from a customer device. The order process provides a request for acceptance of the booking to a vehicle device of a located vehicle. The locator process enables payment for a customer trip in the vehicle. Payment is enabled when the customer device and vehicle device are determined by the locator process to be within a predetermined proximity of each other.

### FIELD OF THE INVENTION

The present invention relates to a method and system for facilitating public transport, and particularly, but not exclusively, to a method and system for facilitating booking and payment for taxi cabs.

### BACKGROUND OF THE INVENTION

Taxi cab booking systems are well known. They are implemented in a number of ways. The majority of known systems take telephone bookings from customers and use radio or other two-way communication systems to obtain booking acceptance from drivers of taxis who wish to take the customer booking. Known systems suffer from a number of problems.

One problem is how to keep the customer updated about progress of their booking. Often, the customer is not updated at all unless they telephone back into the system.

Another problem is, even where a booking has been accepted, the customer has no reliable way of knowing how long it will be before their taxi arrives. They can telephone back into the system and obtain an estimate of time.

Another problem is that a customer may be unable to obtain a taxi, because there are a limited number of taxis in their area.

There are currently a number of ways available that a customer can pay for a taxi. Often, cash or credit card is required to be handed over to the driver. Bespoke cab payment systems are also known, which usually require the customer to have a card or some form of ticket. Payment by cash has its problems, in particular, drivers don't like to carry large amounts of cash because of the possibility of crime. Credit cards and bespoke cab payment systems also have problems, in that card numbers can be misappropriated for fraudulent use.

### SUMMARY OF THE INVENTION

In accordance with a first aspect, the present invention provides a vehicle booking processing system, comprising a locator process arranged to obtain location of a vehicle for hire, and an order process arranged to receive a booking order from a customer device and provide a request for acceptance of the booking to a vehicle device of a located vehicle, wherein the order process is arranged to receive bid data from the customer device, the bid data representing an amount of additional credit that a user will pay in addition to a vehicle fare, and wherein the order process is arranged to receive condition data, the condition data providing a condition associated with the vehicle trip, the condition being required to be satisfied in order for the additional credit to be paid.

Additional credit may comprise positive credit (money to be paid over the fare) or negative credit (money to be paid less than the vehicle fare).

The bid data may represent an extra fare that the customer will be willing to pay if the vehicle satisfies a condition such as arriving to pick up the customer within a predetermined time period. If that condition is not satisfied, the additional fare is not paid. This provides an incentive to a driver to accept a booking and arrive within a predetermined time.

In an example, the extra fare bid may be provided because there are few available cabs, and the customer wishes to provide an incentive to obtain one taxi from the few available ones.

In another example, there may be many taxi cabs available to provide the service. In such circumstances, the bid data may indicate that the customer would be willing to pay less than the usual fare (because there are so many taxis available). A taxi driver may then accept the booking, even though they will obtain less than the usual fare, because it is not a busy period for them.

The customer device may comprise a computing device, such as a PC or laptop, or a mobile computing device or telecommunications device, such as a mobile phone, Smartphone, tablet computer or other mobile device. The vehicle device may similarly comprise a computer which may be installed in the vehicle, or may be an otherwise mobile device such as a Smartphone, mobile phone, tablet computer or other mobile device.

The locator process may comprise any known way of obtaining the location of the customer device, such as GPS, cellular network or any other telecommunications network triangulation, or any other way of obtaining the location.

In an embodiment, location of the vehicle for hire is obtained by obtaining the location of the vehicle device. In an embodiment, the location of the customer device is also obtained.

In an embodiment, the system may be arranged to advise the customer device of the current location of a booked vehicle, as the locator process can track the location of the booked vehicle. Advantageously, this enables the customer to be kept up to date with the progress of the booked vehicle.

In an embodiment, the order process is arranged to enable the driver and/or passenger to facilitate a penalty fee agreement. A penalty fee may be implemented dependent on a determined penalty fee condition.

In an embodiment, the penalty fee may comprise a driver penalty fee and the penalty fee condition may be a driver condition, such that if the driver does not provide the required service, the driver penalty fee may be implemented and the penalty fee paid to the passenger. In an embodiment, the condition may be that the driver must collect the passenger. If the driver does not pick the passenger up, they pay the penalty fee. The condition may also be the driver does not cancel. If the driver cancels and/or does not arrive, then the passenger gets the penalty fee.

In an embodiment, the penalty fee may comprise a passenger penalty fee. If a passenger does not provide an appropriate response to a booking, then the driver may receive the penalty fee from the passenger. In an embodiment, if the passenger cancels or is not present at the pick up destination, then the driver may receive the penalty fee.

In an embodiment, the system further comprises a payment process, to enable payment for a customer trip in the vehicle. In an embodiment, payment is enabled when the customer device and the vehicle device are determined by the locator process to be within a predetermined proximity of each other.

In an embodiment, payment is enabled by the payment process providing the customer device or vehicle device with identity of the respective vehicle device or customer device (or associated vehicle or associated customer), respectively, so that payment can be made via one of the customer device or vehicle device.

In an embodiment, the processing system comprises a database which is arranged to store customer account details enabling the payment process to deal with payment from a customer account. The database may also store taxi company account details, enabling payment from the customer account to the taxi company account (or taxi owner account or like account). Advantageously, the system is able to deal with the payment process when instructed by operation of a customer device and/or vehicle device. In an embodiment, no secure details, such as credit card details, need be exchanged between the customer and the taxi driver. Payment is, instead, carried out via the system, using the details stored in the database.

In an embodiment, the payment process is arranged to determine customer devices and vehicle devices that are in a predetermined area. The identities of the customer or vehicle devices in the area are provided to the respective vehicle device or customer device (whichever one of these is making the payment). The appropriate customer device or vehicle device to make payment to/from can then be selected from those provided by the payment process as being within the predetermined area. This advantageously means that payment is only made between the parties that are likely to be the correct parties, because their respective customer and vehicle device are in the same geographical location.

In the embodiment where the order process is arranged to facilitate a penalty fee agreement, the payment process may be arranged to implement the payment of the penalty fee. In an embodiment, the payment process may make a determination as to whether the penalty fee is to be implemented based on whether or not the penalty fee condition has been satisfied. In an embodiment, the locator process is arranged to facilitate a determination of whether or not the condition has been satisfied.

In an embodiment, the customer and driver may operate their respective devices to agree that a penalty fee will be implemented. In another embodiment the system may determine that a penalty fee should be implemented without the customer or driver having to operate their devices to agree to a penalty fee. That is, the system could be set up de facto to implement a penalty fee for customers and drivers that subscribe to the system.

In accordance with a second aspect, the present invention provides a customer processing device arranged for use with a vehicle booking processing system, the customer processing device comprising a booking process arranged to enable provision of a booking order to the processing system.

The customer processing device may comprise a computing device, such as a PC or a laptop, or a Smartphone, tablet computer, mobile phone or any telecommunications device. In an embodiment, an application comprising the booking process may be supported by the customer processing device. For example, the booking process may be provided by a Smartphone application.

In an embodiment, the customer processing device may be arranged to provide bid data to the vehicle booking processing system. In an embodiment, the customer processing device may be arranged to provide condition data to the vehicle booking processing system. In an embodiment, the customer process device may be arranged to agree a penalty fee should a penalty fee condition not be satisfied.

In an embodiment, the vehicle booking processing system is the vehicle booking processing system of the first aspect of the invention.

In accordance with a third aspect, the present invention provides a vehicle processing device, arranged for use with a vehicle booking processing system, the vehicle processing device comprising an acceptance process arranged to receive a request for acceptance of a booking of the vehicle associated with the vehicle device, from the vehicle booking processing system.

In an embodiment, the vehicle processing device may comprise a computing device, which may be installed on the vehicle associated with the vehicle processing device, which is a bespoke computing device, a PC, or a laptop, or may comprise an otherwise mobile device, such as a Smartphone, tablet computer, mobile phone or any telecommunications device. In an embodiment, an application comprising the acceptance process may be supported by the vehicle processing device. For example, the acceptance process may be provided by a Smartphone application.

In an embodiment, the vehicle processing device is arranged to receive bid information advising of an amount of bid placed by a customer relating to an amount extra (or less) to be paid for a vehicle trip. In an embodiment, the vehicle processing device is arranged to receive condition data, advising of a condition associated with the vehicle trip.

In an embodiment, the vehicle processing device may be arranged to facilitate agreement of a penalty fee, should a penalty fee condition not be satisfied.

In an embodiment, the vehicle booking processing system is in accordance with the first aspect of the present invention.

In accordance with a fourth aspect, the present invention provides a vehicle booking and payment processing system, comprising a locator process arranged to obtain location of a customer device and location of a vehicle device associated with a vehicle, and to anble payment for a customer trip in the vehicle, payment being enabled by the locator process determining the customer device and vehicle device are within a predetermined proximity and by the payment process providing the customer device or vehicle device with identity of the respective vehicle device or customer device, respectively, so that payment can be made by selection by one of the customer device or vehicle device.

Payment is enabled by the payment process providing the customer device or vehicle device with the identity of the respective vehicle device or customer device (or associated customer or associated vehicle), so that payment can be made by one of the customer device or vehicle device.

In an embodiment, there may be a plurality of customer devices and vehicle devices within the predetermined proximity. The payment process enables the customer device or vehicle device, whichever is facilitating the payment, to select which customer/vehicle identity the payment transaction is to be between.

In accordance with a fifth aspect, the present invention provides a vehicle booking processing system, comprising an order process arranged to receive a booking order from a customer device, and provide a request for acceptance of the booking to a vehicle device associated with a vehicle, the order process being arranged to receive bid data from the customer device, the bid data representing an amount of additional credit that a user will pay in addition to a vehicle fare.

In an embodiment, the order process is also arranged to receive condition data from the customer device. The condition data provides the condition associated with the vehicle trip, the condition being required to be satisfied in order for the additional credit to be paid.

In an embodiment, the processing system further comprises a payment process, the payment process being arranged to determine whether the payment of the additional credit is enabled to be made. In the embodiment which comprises the provision of condition data, the payment processor is arranged to determine whether the condition is satisfied, in order to enable the additional credit payment to be made.

The additional credit may be a positive credit (further funds to be paid over the top of the vehicle fare) or a negative credit (less funds to be paid than the amount of the vehicle fare).

In accordance with a sixth aspect, the present invention provides a method of booking a vehicle, comprising the steps of receiving a booking order from a customer, providing a request for acceptance of the booking order to a vehicle, receiving bid data from a customer, the bid data representing an amount of additional credit that a user will pay in addition to a vehicle fare.

In an embodiment, the method comprises the further step of providing the bid data to the vehicle.

In an embodiment, the method comprises the further step of receiving condition data from a customer, the condition data relating to a condition to be satisfied in order for the additional credit to be paid.

In accordance with a seventh aspect, the present invention provides a method of booking and paying for a vehicle trip, comprising the steps of obtaining location of a customer and location of a vehicle, and enabling payment for the customer trip by determining that the customer and vehicle are within a predetermined proximity and providing the customer or vehicle with the identity of the respective vehicle or customer, whereby the customer or vehicle may be selected for payment.

In accordance with an eighth aspect, the present invention provides a vehicle booking processing system, comprising a locator process arranged to obtain location of a passenger within a vehicle for hire, and an information process arranged to provide information on the location of the person to a companions device, and the identity of the vehicle, whereby the companion can track the location of the person.

In an embodiment, the location of the vehicle is obtained by tracking the location of a device within a vehicle.

In an embodiment, the device may be a customer device of the customer travelling in the vehicle.

In an embodiment, the device may be a device associated with the vehicle.

In accordance with a ninth aspect, the present invention provides a vehicle booking processing system, comprising an order process arranged to receive a booking order from a customer device, and provide a request for acceptance of the booking to a vehicle device associated with a vehicle, the customer device and/or vehicle device being arranged to determine and agree a penalty fee and a penalty fee condition, the system being arranged to determine whether a penalty fee should be implemented, based on whether the penalty fee condition has been satisfied.

The user may be a driver of the vehicle or a customer.

In accordance with a tenth aspect, the present invention provides a method of booking a vehicle, comprising the steps of receiving a booking order from a customer, providing a request for acceptance of the booking order to a vehicle, the customer and/or vehicle operator being arranged to determine and agree a penalty fee and a penalty fee condition, and determining whether a penalty fee condition has been satisfied.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic diagram of a system in accordance with an embodiment of the present invention;

FIG. 2 is a schematic diagram of a computer implementation of the system of FIG. 1;

FIG. 3 is a flow diagram showing an overall vehicle booking and payment process in accordance with embodiments of the present invention;

FIG. 4 shows illustrations of pages which may appear on computer device interfaces associated with a system in accordance with an embodiment of the present invention;

FIG. 5 are further illustrations of pages which may appear on computer device interfaces associated with the system in accordance with an embodiment of the present invention;

FIG. 6A are further illustrations of pages which may appear on computer device interfaces associated with the system in accordance with an embodiment of the present invention;

FIG. 6B are further illustrations of pages which may appear on computer device interfaces associated with the system in accordance with an embodiment of the present invention;

FIG. 6C are further illustrations of pages which may appear on computer device interfaces associated with the system in accordance with an embodiment of the present invention;

FIG. 7A are further illustrations of pages which may appear on computer device interfaces associated with the system in accordance with an embodiment of the present invention;

FIG. 7B are further illustrations of pages which may appear on computer device interfaces associated with the system in accordance with an embodiment of the present invention;

FIG. 8A are further illustrations of pages which may appear on computer device interfaces associated with the system in accordance with an embodiment of the present invention;

FIG. 8B are further illustrations of pages which may appear on computer device interfaces associated with the system in accordance with an embodiment of the present invention;

FIG. 9 is a schematic flowchart illustrating operation of a system in accordance with an embodiment of the present invention;

FIG. 10 is a further schematic flowchart illustrating operation of an embodiment of the present invention;

FIG. 11 is an illustration of a screen which may appear on a customer device in an embodiment of the present invention where the penalty fee may be imposed should a condition not be satisfied by a user; and

FIG. 12 is a view of a screen which may appear on a vehicle device in an embodiment where a penalty fee may be imposed if a condition is not satisfied.

### DETAILED DESCRIPTION OF EMBODIMENTS

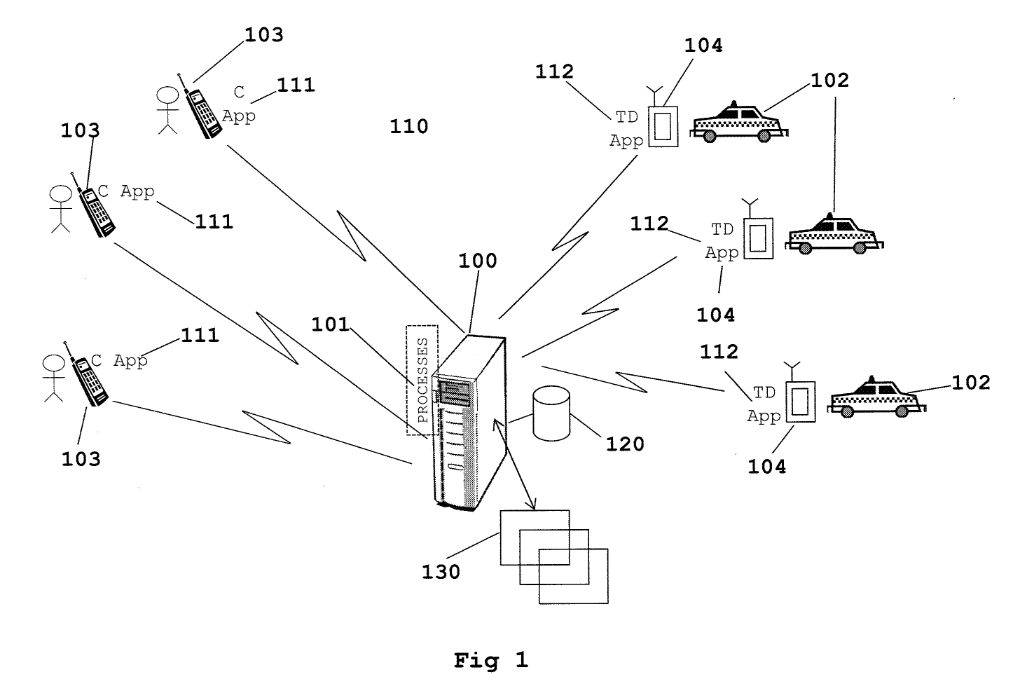

Referring to FIG. 1, a vehicle booking processing system 100 is illustrated. In this example embodiment, the vehicle booking processing system 100 comprises a computing device in the form of a server computer 100, with appropriate software and appropriate hardware. The processing system 100 includes at least a location process (in the form of a combination of software and hardware for implementation of a location procedure) 101 which is arranged to obtain location of a vehicle for hire.

In this example, vehicles for hire are illustrated in FIG. 1 and designated by reference numeral 102. In this embodiment, the vehicles are taxi cabs. The invention is not limited to taxis, however, but may be applied to any public transport vehicle to be hired by a customer.

The processes 101 implemented on the processing system 100 also include an order process which is arranged to receive a booking order from a customer device. The booking order includes a request for booking of a vehicle 102. The customer devices, indicated by reference numeral 103, include an interface for operation by a customer to provide booking order instructions for the order process. In this embodiment, the customer devices 103 are mobile computing devices, such as Smartphones or tablet computers. The invention is not limited to this, however, and customer devices may be any computing device with a processing and telecommunications function, including a PC, laptop, or any mobile computing device.

The order process 101 is arranged to provide a request for acceptance of the booking to a vehicle device 104 associated with a vehicle 102. The vehicle device 104 can accept the booking and then the vehicle 102 can pick the customer up, convey them to a destination and drop them off. In this embodiment, the system 100 is also arranged to implement a payment transaction from a customer to a taxi company (or other taxi owner). Processes 101 also comprise a payment process for dealing with the payment transaction.

The vehicle devices 104 may be any computer device with a processing and telecommunications capability. They may be bespoke computing devices installed in the taxis 102, or generic computing devices, such as Smartphones or tablet computers.

The order process 101 is arranged to receive bid data from a customer device 103. The bid data represents an amount of additional credit that a user will pay in addition to a vehicle fare. This bid data is provided to the vehicle device 104, in order to provide an incentive for the vehicle 102 driver to take the booking.

The locator process 101 is arranged to determine the location of vehicle 104 and the customer 103, in this embodiment, using GPS, cellular triangulation, or any other method of obtaining location of the devices 103, 104. The payment process is arranged to enable payment for a customer trip in the vehicle, the payment being enabled when the customer device 103 and the vehicle device 102 are determined by the locator process to be within a predetermined proximity of each other.

In more detail, the processing system 100 may be implemented by any convenient computing architecture. In this example, the processing system 100 is implemented as a server computer, arranged to be connected to a network(s) 110, which may be any telecommunications network(s).

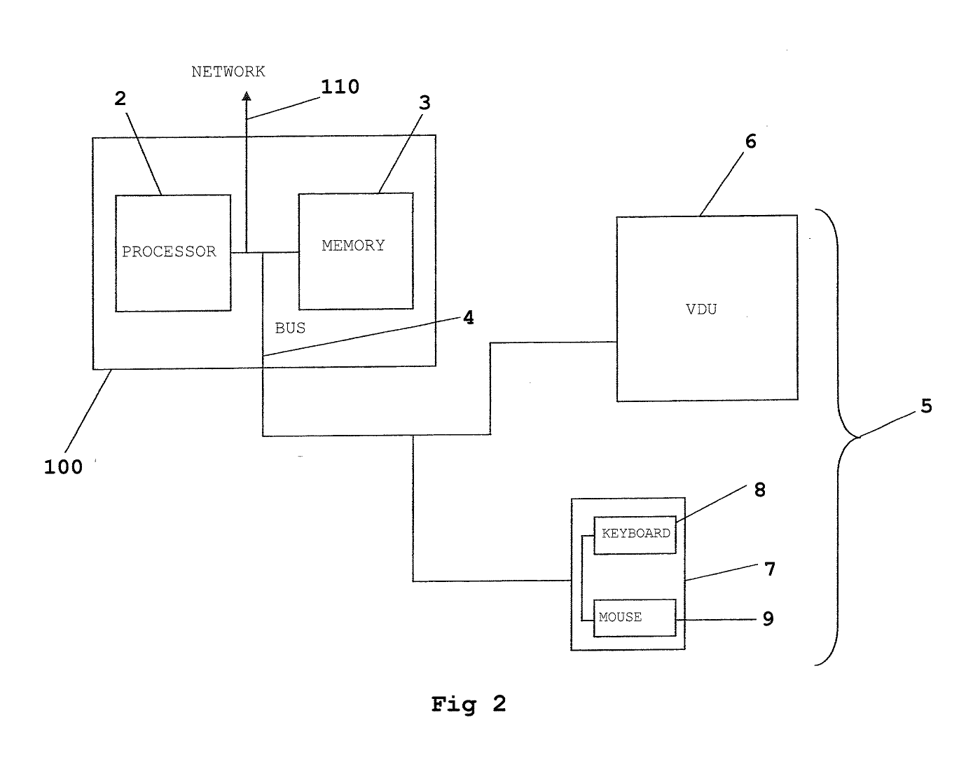

FIG. 2 is a schematic block diagram of an example computing system 100 architecture which may be utilised for implementation of the processing system 100.

The illustrated processing system 100 comprises a server 100 which includes a processor 2 and memory 3. The processor 2 is arranged to process programme instructions and data in a known manner. Memory 3 is arranged to store programme instructions and data also in a known manner. Processor 2 may constitute one or more processing means, such as integrated circuit processes. The memory 3 may comprise any known memory architecture and may include hard disk, IC memory (ROM, PROM, RAM, etc), floppy disks and other types of additional memory such as CD ROM, and any other type of memory.

A BUS 4 is provided for communication between the processor 2 and memory 3 and also communication with external components. In this case the external components include a user interface 5. The user interface 5 includes a visual display unit 6 for displaying information to a user, such as an administrator of the system 100. The VDU 6 may display information in graphical format or any other format depending upon the programme instructions being processed by processor 2.

The user interface 5 also includes user input means 7 which in this example include a keyboard 8 (which in this example may be a standard QWERTY keyboard) and a mouse 9. The mouse 9 may be used to manipulate a graphical user interface (GUI) if a GUI is provided by software running on the computer. A network connection 10 is also provided for connecting to a network 110 which may include a communication network and other computers/computing systems, or any telecommunications network.

Any other computing architecture may be used to implement the processing system 100.

The processes 101 in this embodiment are implemented by appropriate computer software running on the hardware architecture. However, the processes 101 may be implemented by any combination of hardware and software, and may be implemented using programmable hardware devices such as electrically programmable read-only memories, or programmable gate arrays (PGAs), or any other suitable implementation. The processes 101 are arranged to implement the functionality described in this description.

The system 100 may be implemented on a computing system which is remotely administered. For example, the system 100 may be implemented via “cloud” computing systems.

The customer devices 103 in this embodiment are implemented on Smartphones or tablet computers, and the functionality is implemented by way of software running on the Smartphone or tablet computers 103. In this embodiment, a customer application, in the form of software, referenced by numeral 111, is provided by the system 100 to the user's Smartphone 103. Any other user device and computer software combination may be used to implement the customer device 103, including programmable hardware, such as PGAs and FPGAs.

In FIG. 1, three customer devices 103 are shown. This is for illustration only. It will be appreciated that there may be many more customer devices than this.

The vehicle device 104 in this embodiment is implemented by a Smartphone, provided with a taxi driver application 112. The taxi driver application 112 may be provided by the system 100. It may comprise appropriate software running on the Smartphone hardware. It will be appreciated that the application may be implemented in other ways, including in hardware devices such as PGAs, or any other implementation.

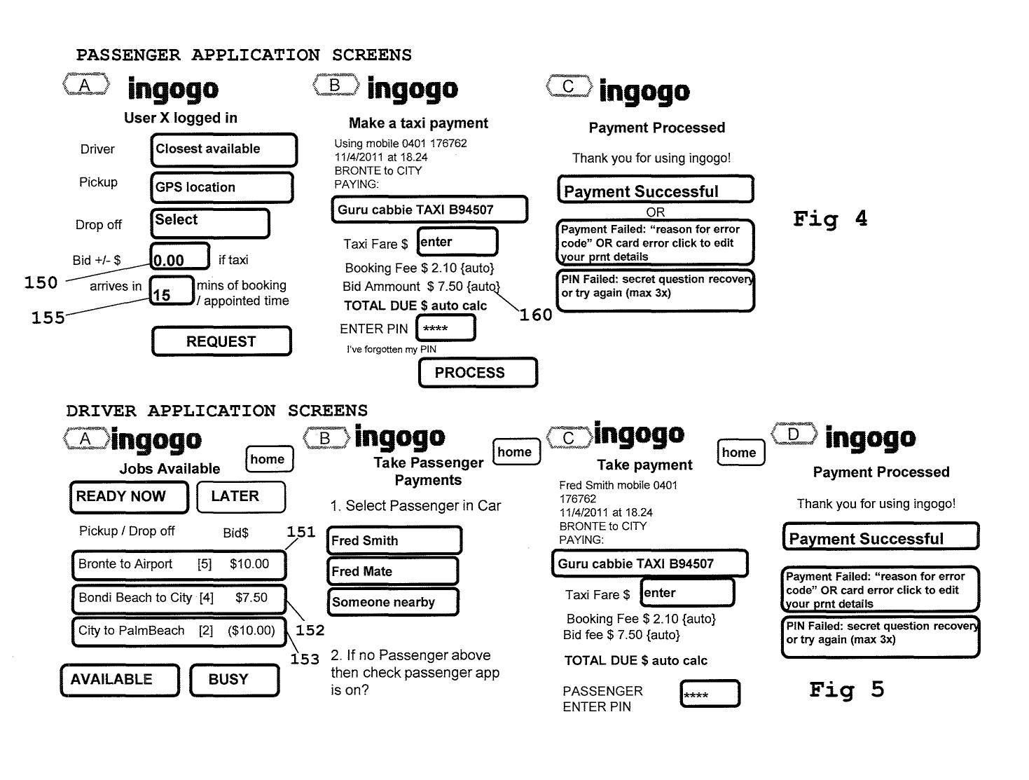

An advantageous aspect of this embodiment of the invention is that, in a booking process, a customer is able to provide bid data from customer device 103, the bid data representing an amount of additional credit that a user will pay in addition to the usual vehicle fare. FIG. 4 shows representations of screens which may appear on the customer device 103 during the process of booking. Screen 4A shows the customer logged into the system 100 to make a booking. A field is provided at 150 for the customer to enter a plus or minus bid. This is then provided as bid data to the system 100 and it appears on a driver application screen as shown in FIG. 5A. FIG. 5A shows fields 151, 152 and 153 showing three different jobs that the driver may select from, having three different bids. Note that 153 is a negative bid. That is, the customer is bidding less than the normal fare. It may be the case that in this particular area, there are more cabs available than jobs, so the customer believes that they can still obtain a vehicle even though they are not willing to pay the full fare.

Referring back to FIG. 4A, the customer application also provides a field at 155 for the customer to enter a condition. This is provided as condition data to the system 100. The condition in this embodiment is the time of arrival of the taxi at the pickup point. If the taxi arrives within 15 minutes (in this illustration) of booking, then the bid will be paid. The customer therefore may only pay the extra credit over the fare, if the taxi driver satisfies the condition that they arrive to pick the customer up within 15 minutes of the booking.

Any other condition may be implemented.

The normal taxi fare is typically calculated by the taxi meter or some other calculation system. Many different response time conditions may be implemented. Examples include a bid of $10 over the meter if the taxi arrives within 30 minutes, a bid $10 under the meter to go city to Palm Beach in the next two hours, or a bid $20 over the meter if the taxi arrives at a particular time.

Other conditions alternatively or as well as response time may be implemented.

The system knows the location of the driver and the driver can view on their driver application screens all bids within a certain radius of their location and can accept bids based on conditions.

Note that bids don't have to have any particular conditions attached to them. A bid on its own may provide an incentive to a driver.

The bid process is not just limited to taxis (as discussed above) but can apply to any form of passenger transport where a passenger is collected.

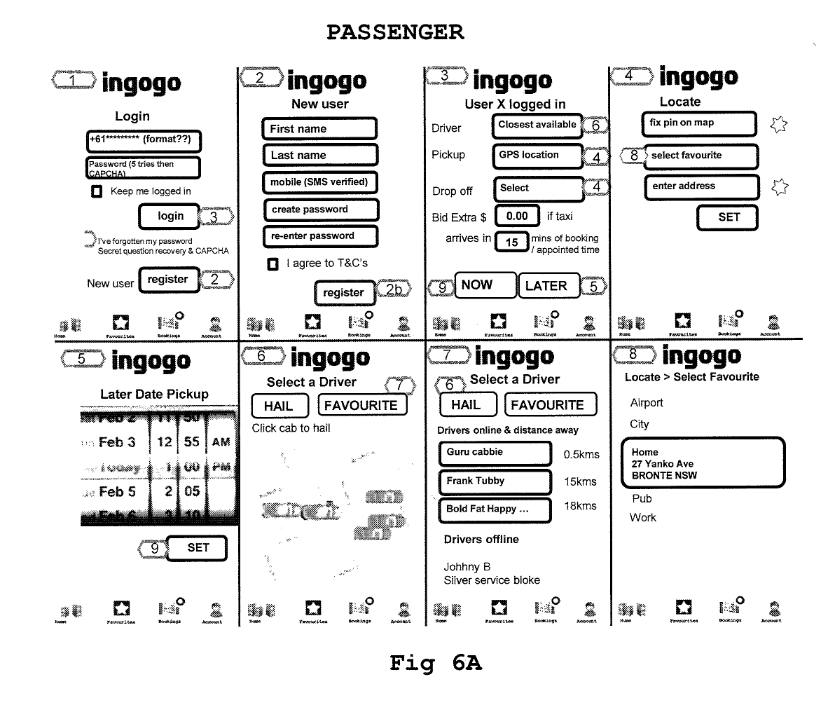

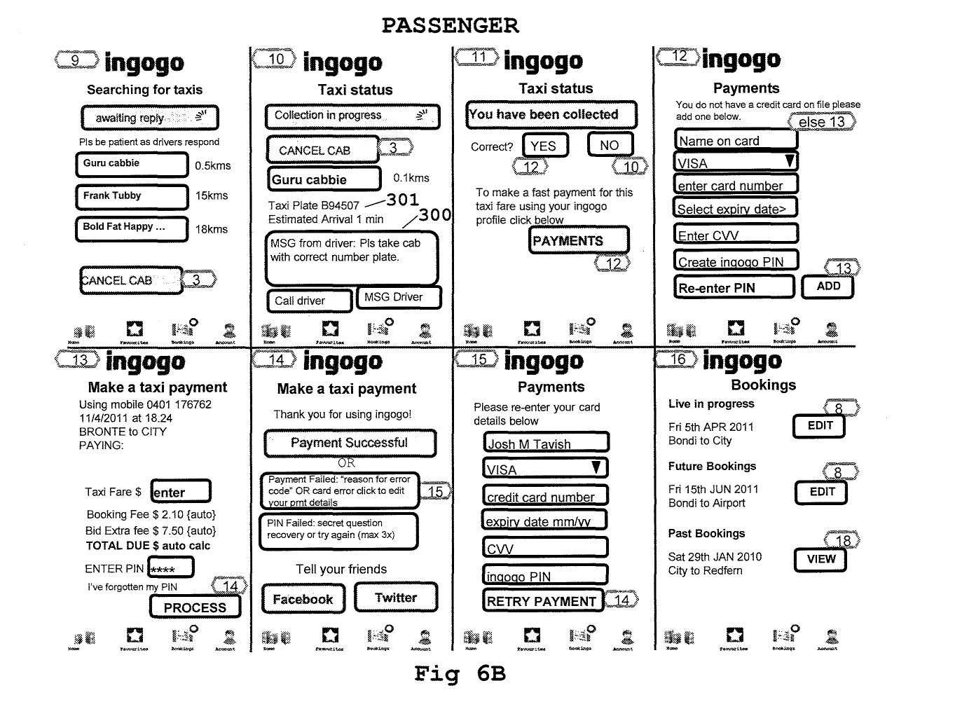

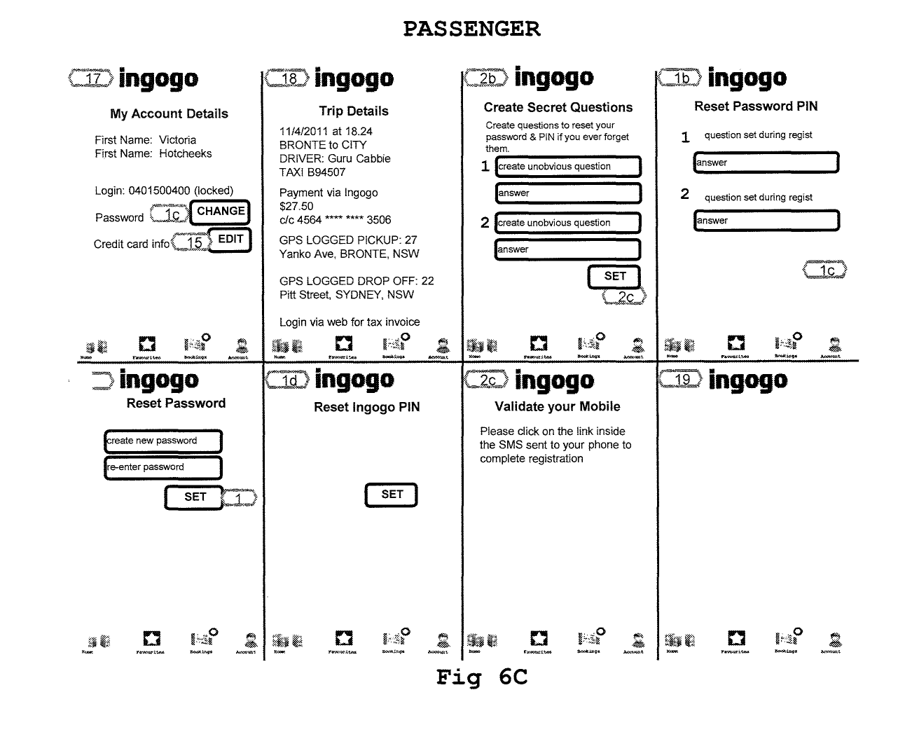

When a customer logs into the system via their device 103 and customer application 111, because the system 100 knows the location of vehicles, the present embodiment can provide details of the vehicles that are within the vicinity (a predetermined proximity) of the customer. Referring to FIG. 6a (6) shows a screen which might appear on the customer application, illustrating a number of cabs, shown by vehicle icons, in the vicinity of the customer. The customer can click one of the cabs to indicate that they wish to book them (via the system). This also provides information to the customer about how many cabs are in their vicinity, which may assist with the bidding process. If there are a lot of vacant cabs, for example, the customer may feel that they can provide a bid under the cost of the normal taxi fare. Otherwise, if there are only a limited number of cabs, they may wish to provide an incentive, such as a bid of credit over the standard taxi fare.

In this embodiment, because the system 100 includes a locator process 101 which is able to track the location of the vehicle devices 104 and customer devices 103, a payment process 101 is arranged to determine whether a condition entered by customer 103 and accepted by a vehicle device 104 is satisfied. The payment process is arranged to track location of customer 103 and customer 104 and if the locations converge within a time set by the condition (if the condition is a time period by which the customer must be picked up, for example), then the payment process 101 may decide that the particular condition has been satisfied. The payment process will then set the additional credit to be paid automatically. The system 100 therefore acts as a “referee” in this embodiment. Whether the bid amount is to be paid will be calculated automatically and determined based on the locator process and payment process. See screen B in FIG. 4 at 160 which shows fields indicating that the booking fee and bid amount are calculated automatically.

If the system 100 determines that the condition has not been satisfied, the bid amount may not be paid and may therefore not automatically be added to the payment.

As discussed above, the system 100 comprises a payment process 101. The payment process facilitates dealing with payment from the customer to the taxi owner (which may be a taxi company, taxi driver, or any other taxi owner). The payment process also implements a payment security measure, in this embodiment. The locator process is arranged to track the location of the customer device 103 and the vehicle device 104. The payment process enables payment when the customer device 103 and the vehicle device 104 are within a predetermined proximity to each other. This provides an extra element of convenience, as during the payment process, whoever is paying (and payment can take place via the vehicle device 104 or customer device 103 in this embodiment) is provided with a selection of only those customers/vehicles that are in proximity of each other. Whoever is dealing with the payment, the customer or the vehicle driver, is only presented with the customer/vehicle owner'details of those that are in proximity. They can select from these to implement the payment transaction. It provides security because the location tracking ensures that only payment will therefore occur between customers/drivers who are in proximity to each other (or at least their devices are in proximity to each other) which provides more assurance that they are who they say they are.

In one example, the driver may deal with the payment via the vehicle device 104. FIGS. 5B, C and D show vehicle device application screens which facilitate a payment process dealt with by the driver. Because of the locator process, the taxi driver application is able to display all passengers within the same geographical location, and also display on the application all available payment profiles which the transaction may be charged to. See screen B. The driver selects the correct payment profile, enters the payment amount and then hands the device to the passenger for the passenger to enter their PIN or password (see screen C). Once the transaction is approved, both the driver and passenger receive confirmation (see screen D and also see screen C of FIG. 4).

At the end of a successful payment, the driver can enter a passenger's mobile number or email account into the vehicle device 104 so that a receipt may be sent electronically to the passenger. The vehicle device 104 may also facilitate generation of a conventional paper receipt.

If the passenger is to deal with the payment, on the customer application, they are able to see profiles of all drivers within the same geographical location as them (see FIG. 4B). The passenger selects the appropriate driver via the customer application, enters the trip payment amount and the system may optionally confirm the amount on the driver's application. As discussed above, a booking fee and bid amount may automatically be calculated by the system. The passenger enters a payment PIN or password to authorise the transaction. Both receive a payment confirmation (FIG. 4C and FIG. 5C).

As discussed above, there is no need for secure payment details to be passed between a driver and a customer. In this embodiment, the system 100 includes a database 120, which includes payment and account details for all customers. For example, it may include details of customer credit card accounts. Optionally, it may also include customer home address details so that these could be provided automatically to the driver.

The database 120 also may include details of taxi owner accounts.

Ideally, the system generates a unique code that enables a passenger to retrieve payment details from an associated website. The code may be documented on passenger receipts (either electronic or paper), sent to the passenger's email account or mobile phone, or otherwise distributed to the passenger.

The unique code is ideally linked with a passenger's credit card number within a central database, so that the system can compile a usage history for the credit card. For instance, the system ideally adds new records to a passenger's payment history every time the passenger reuses the same credit card to make a payment.

The payment history database may be linked to a website that enables the passenger to retrieve their receipt history. Ideally, passenger's can access their payment history and retrieve records of past payments by entering a code from any of their receipts. The website may also enable a passenger to produce tax invoices and audit their records in a single dedicated interface.

Ideally, the website also allows a passenger to enter an email address so that new receipts and tax invoices for a particular credit card are automatically distributed to the user when they use that credit card to make a payment.

When payment is processed, the payment process deals with a payment gateway 130, which may deal with the banking systems to process the payment. All that the customer requires is a secure PIN, password or any other token, such as a biometric, to authorise the payment. They do not need to provide secure account details to the driver, such as credit card details.

Note that the payment process may be dealt with by transaction acquirers in the usual way, including banks, credit card companies, etc. In an alternative embodiment, payment may be held by an account associated with the system 100, in escrow, for on-payment to the taxi owner. In an embodiment, the system may administer a taxi account, with customer credit available in the taxi account for later payment to taxi owners when the customer undertakes trips.

In one embodiment, as discussed above, the bid amount may be paid directly to the taxi owner or taxi driver or cab company.

In another embodiment, the bid amount may be paid to the vehicle booking processing system or the owner entity of the vehicle booking processing system.

In an embodiment, the vehicle booking processing system includes a conversion process which is arranged to convert the dollar bids by passengers into “reward points” for drivers. The reward points can be converted later on into money or other goods/services for the driver or taxi company.

In an embodiment, the conversion process is arranged to apply a weighting to the conversion depending upon a service rating calculating for the driver. For example, the service rating may be based on response times to jobs, number of cancelled jobs and passenger feedback, to arrive at an overall “service rating” for the driver for that period. For example, the driver may earn a 90 percent service rating for the month. This could be applied as a weighting to convert the points into cash at a rate of 90 percent of the points, for example (or any other weighting). A driver may not earn conversion of any points if a minimum service level (e.g. 50%) is not reached. Customer bids may be provided for other services, associated with driver pickup.

Passengers can therefore offer the vehicle booking processing system a bid/request for services to be performed. For example:
I'll pay $5.00 service fee to the system IF the system finds a driver who arrives within 30 minutes
I'll pay $20 extra to the system to collect X goods from a person & location
I'll pay $15 extra to the system to find:
   (i) a taxi with 2 baby seats
   (ii) a driver that speaks X language
   (iii) has wheelchair access
   (iv) station wagon with large boot space
   (v) can bring a can of fuel or jumper leads or any other special service request a passenger may request of a driver.

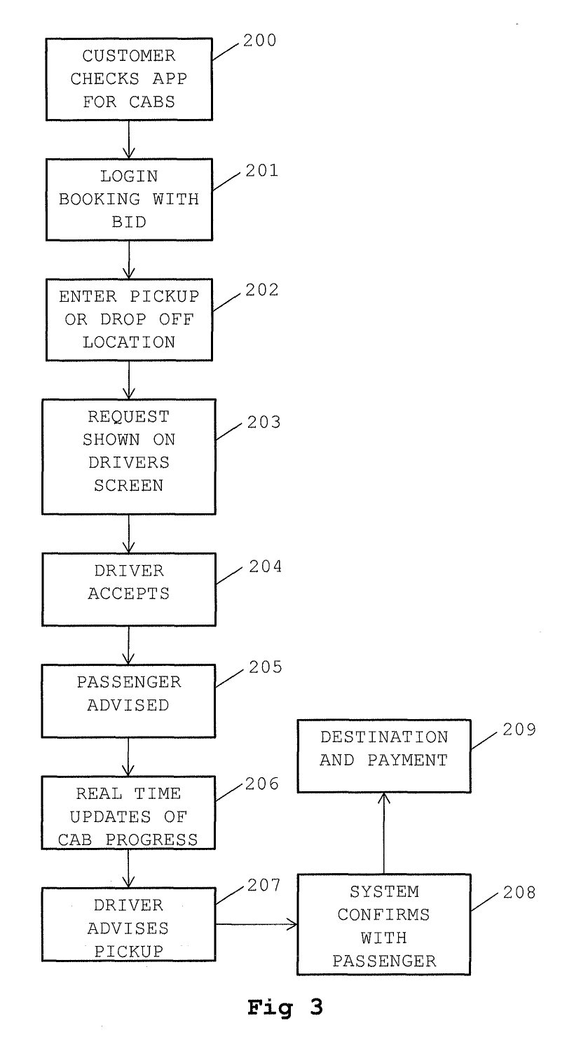

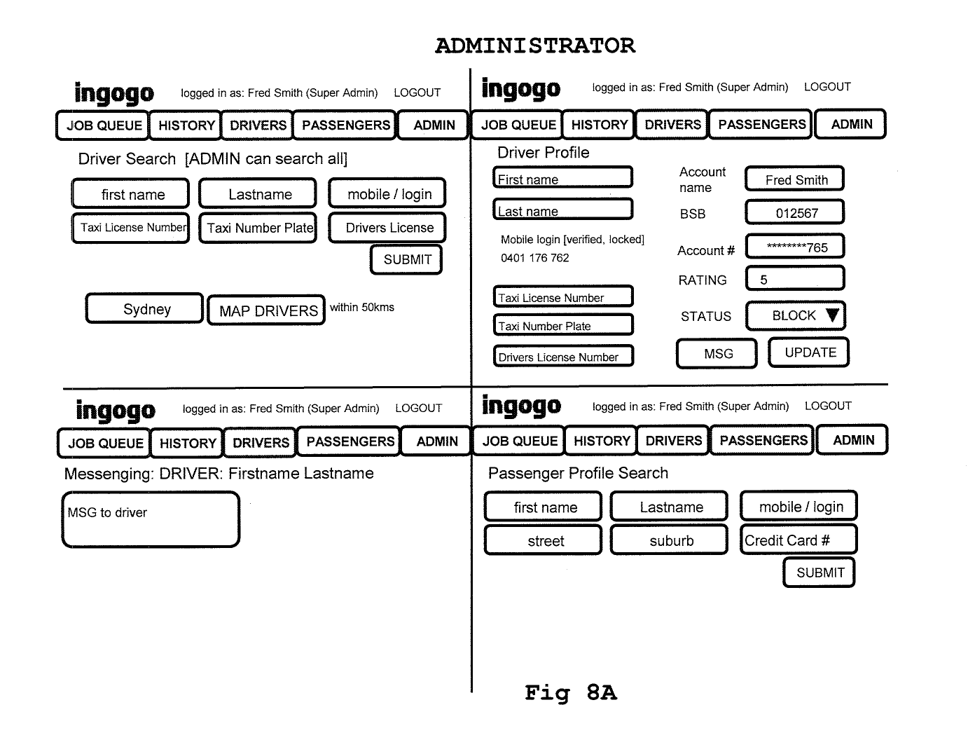

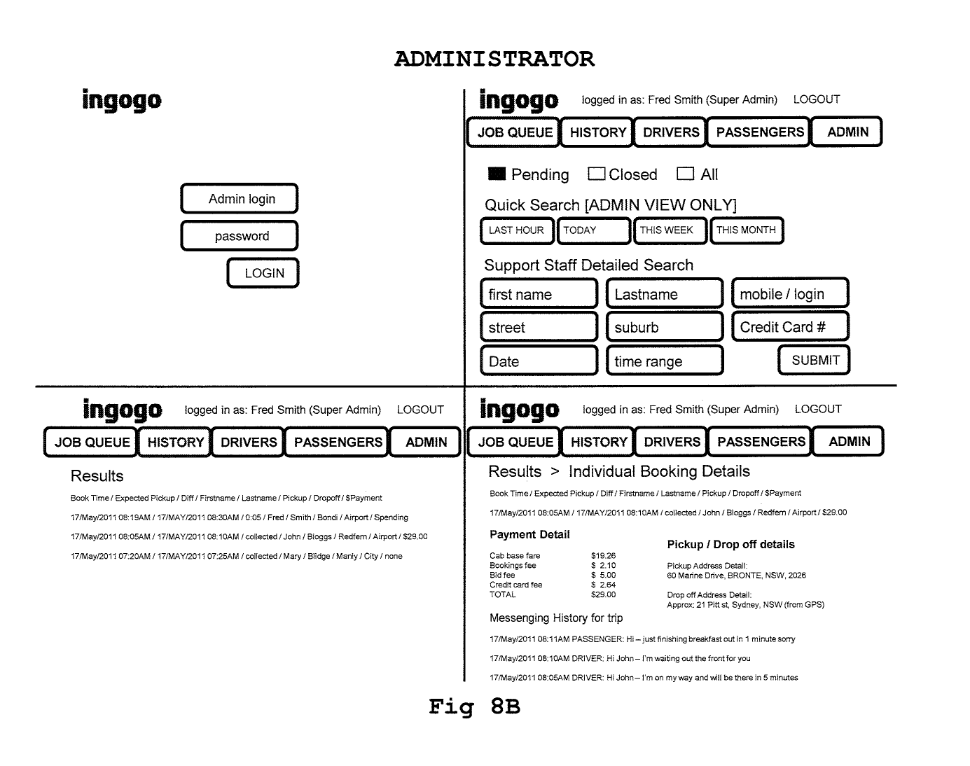

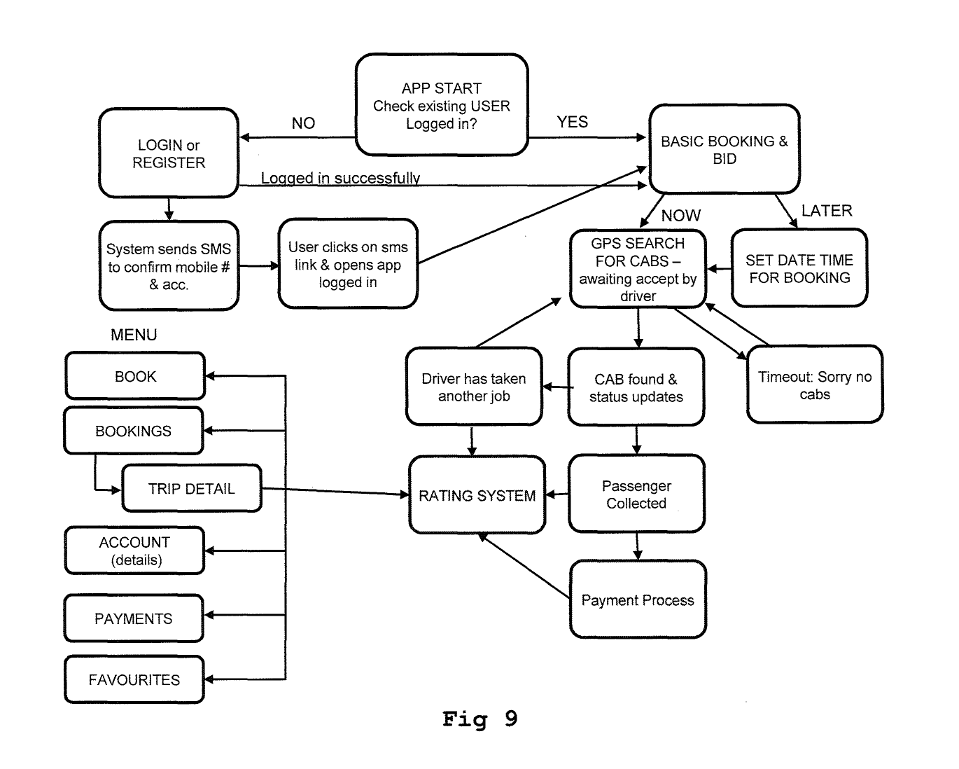

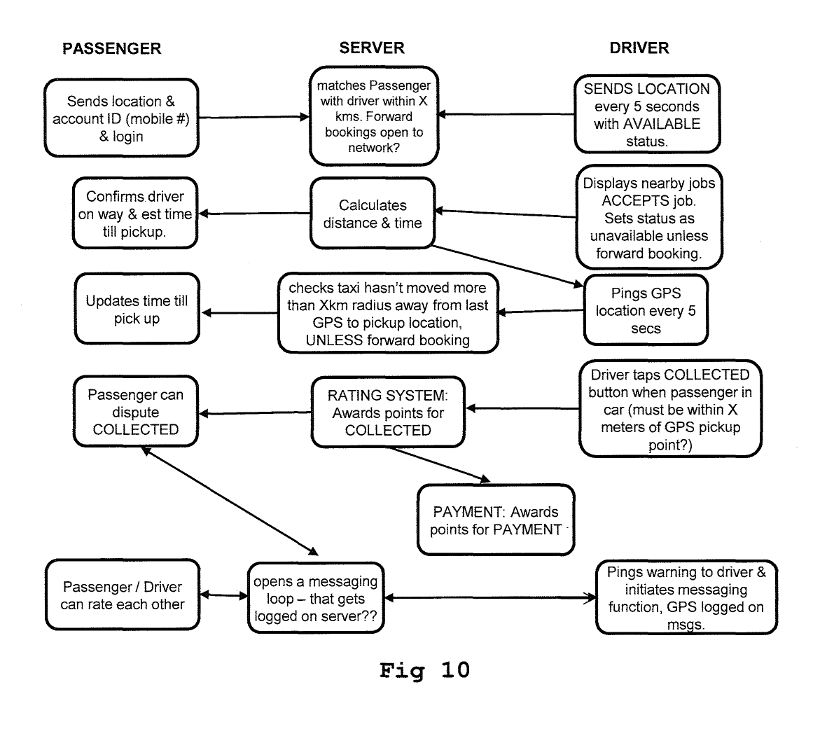

A general process for a trip transaction in accordance with an embodiment of the invention will now be described in relation to FIG. 3, and FIGS. 4 through 10.

At step 200, the customer checks the customer application for taxis in their vicinity. See screen FIG. 6a (6). At step 201, they log into the system and they select a cab and enter a booking with or without a bid. At step 202, they enter their pickup and drop off locations.

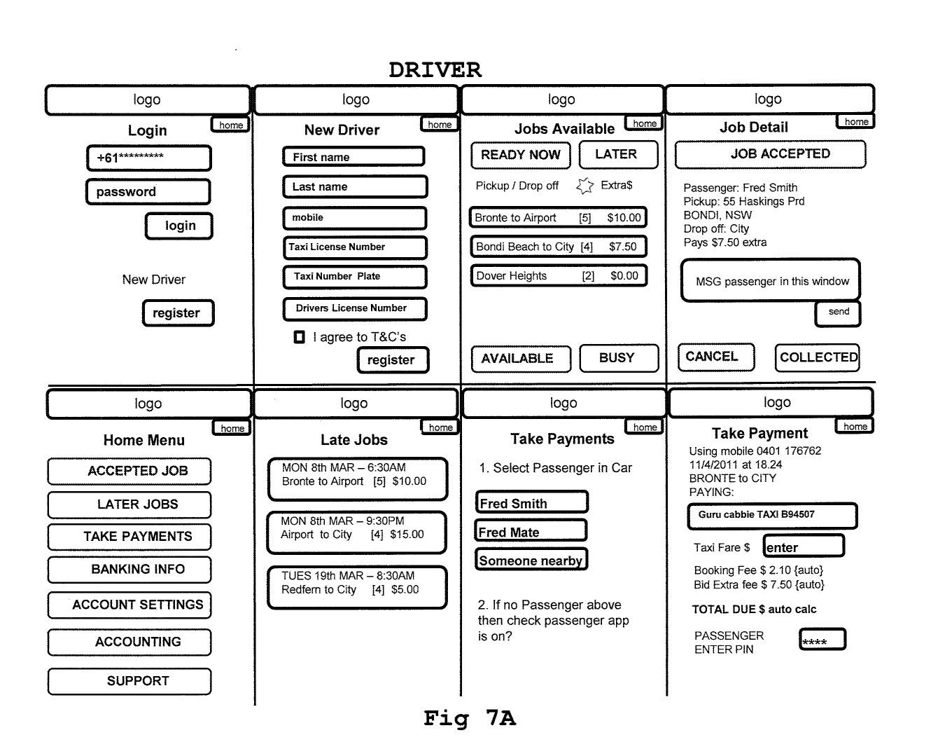

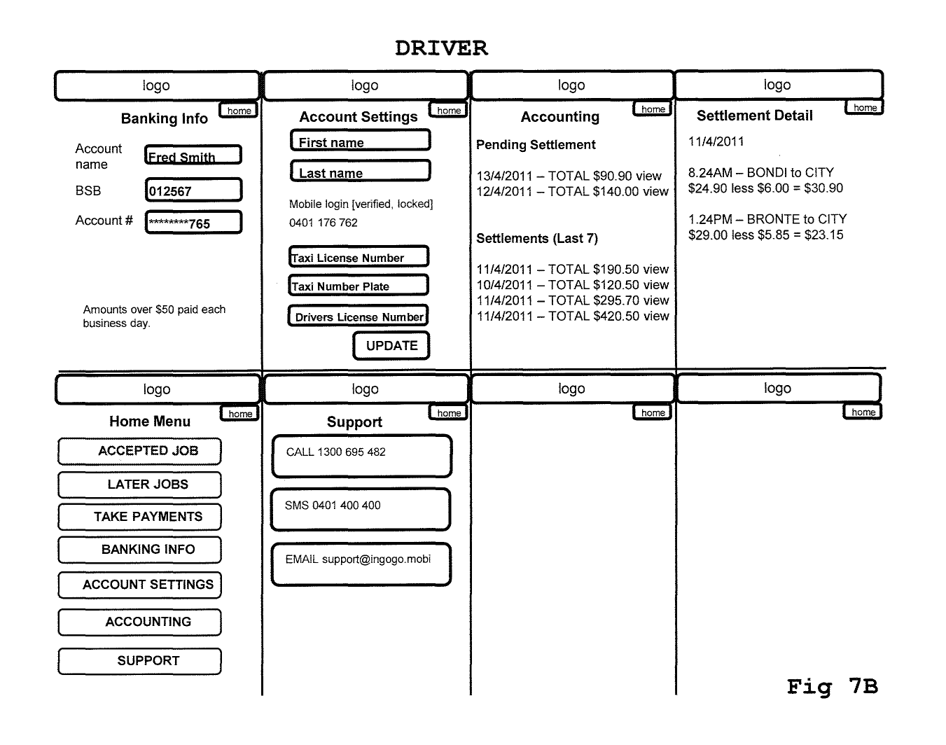

The request for booking is shown on the driver's screen via the taxi driver application (step 203), FIG. 7(a) (3). At step 204, the driver accepts the job. See FIG. 7(a) (4).

At step 205, the passenger is advised that the booking has been accepted. See FIG. 6(b) (10). Note that the system also provides a feature allowing direct messaging between a driver and a passenger, or messaging via the system between the driver and the passenger. See Field 300 on FIG. 6(b) showing a message from the driver. The passenger may also message the driver. See FIG. 7(a) (4).

The system is able to provide real time updates of the taxi progress, step 206. It does this because of the locator process which enables it to track location of the vehicle. See “estimated arrival” time field 301 in FIG. 6(b) (10). This estimated arrival time may be constantly updated. In an embodiment, the passenger may access a screen similar to screen FIG. 6(a) (6) but showing the icon representing the vehicle and its current geolocation.

At step 207, the driver advises the system 100 that the passenger has been picked up. See the “collected” button in FIG. 7(a) (4). The system 100 may then check with the passenger that they have actually been picked up, so that the pickup can be confirmed. See FIG. 6(b) (11), the “YES” and “NO” buttons relating to “you have been collected”. This is step 208. At step 209, the passenger arrives at their destination and deals with payment (either dealt with by the driver or passenger as discussed above).

Other features which are illustrated in the passenger, driver, and administrator's screens associated with the system, include the following:
1. The passenger can book a later pickup date. FIG. 6(a) (5).
2. A passenger can cancel a cab. FIG. 6(b) (10).
3. A registration process is enabled via the customer and taxi driver applications. FIG. 6(c) and FIGS. 7(a) and 7(b).

Other features are clear from the FIGS. 6 through 10.

The passenger and driver can provide ratings for each other that may be posted on the system for viewing by the system administrator, or even potentially viewing by passengers/drivers involved in a booking process.

In an embodiment, the vehicle booking processing system implements a tracking system which enables other persons to track somebody that is in a taxi (or other vehicle). This could be used to ensure that the person being tracked can get safely to a destination.

For example:
1. the passenger's Smartphone application sends the companions (the person being tracked in the cab may be a friend of the person(s) wishing to track) details (e.g. mobile phone number) to the vehicle booking processing system.
2. a check is made to ensure that all persons are registered with the system and if so, will allow the companions to see the passenger trip with their application. This ensures only validated and logged in application users can use their friends trip progress.

3. if anyone is not registered we can use the SMS function or another function to send an application to invite the companion to join.

4. in this embodiment passengers are capped at having “20 friends” that can track them. Though it may be any other number.

Because the system has a tracking process, it is easy to provide results of that tracking process to companions who wish to monitor the progress of a friend's trip.

In an embodiment, the system may be arranged to implement a penalty fee where a penalty fee condition is not satisfied. The penalty fee may relate to a condition to be satisfied by the driver and/or a condition to be satisfied by the customer.

The penalty fee may require the passenger to agree, for example, to pay a fine if they cancel the taxi request or are not at the collection point after the job has been accepted by the driver and he is progressing to collect them.

The jobs are indicated as “insured” to drivers as carrying a “passenger guarantee” on the job screen. The driver by accepting the job also agrees to collect the passenger and pay a reciprocal fine if they do not collect the passenger, so that the passenger gets an amount of collection insurance.

The system facilitates payment of the penalty fee. In one embodiment, the location process determines whether customer and driver have actually been in the same location. If not, it may determine that the pickup has not been made and that one of the customer or driver did arrive at the collection point, therefore the other of the customer or driver that did not arrive at the collection point must pay the penalty fee.

Penalty fees could be implemented for other conditions.

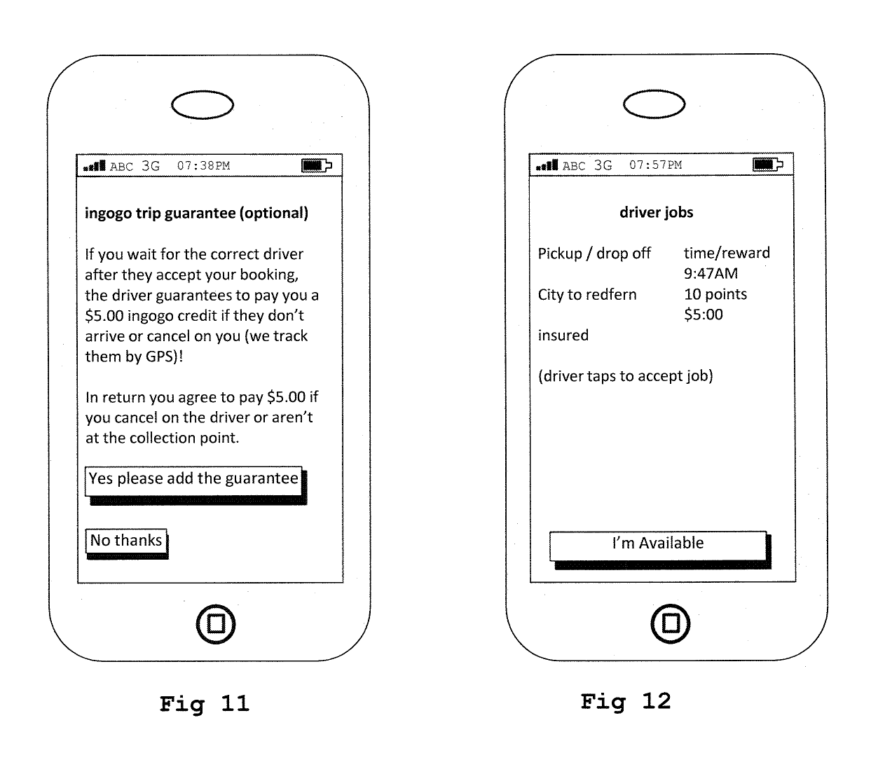

FIG. 11 illustrates an example screen on a customer device, advising the customer that a penalty fee is payable and asking for the customer's agreement. However in other embodiments, a penalty fee may be implemented without asking for customer or driver agreement.

FIG. 12 illustrates a driver device, with the screen indicating to the driver that a penalty fee of $5.00 (“$5.00 insured”) is payable either by the customer (if a customer is not at the collection point, for example) or by the driver if they don't satisfy a predetermined condition (such as arriving at the pickup point within a predetermined time).

A penalty fee may be set for any condition to be satisfied by the passenger and/or driver. Examples of conditions include the following:

Is the driver at the pickup location as calculated by reaching a radius of 500 m (or any other predetermined radius) of the passenger pickup location?
Is the passenger phone still polling GPS location at the pickup address when the driver presses the “no show” button to indicate the passenger isn't there.
Has the driver attempted to message the passenger and wait sufficient time for a reply before pressing the “no show” button, or
Did the passenger press the cancel button.
If these conditions are met, then charge the passengers credit card on file the penalty.
If the driver doesn't reach the collection point in a reasonable time (to be defined, for example, 10 minutes past the agreed collection window), or
presses cancel on the passenger, then
charge the drivers ingogo account and deduct from any fares owed the penalty.
If the passenger cancels within 1 minute of driver accepting, then do nothing, no penalty charged.

Where elements of the embodiment of the invention are implemented by computer software, the computer software may be provided or stored on any computer-readable media, may be transported over any telecommunications system or provided as a data signal, or in any other known manner.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by a person skilled in the art that numerous variations and/or modifications may be made to the present invention as shown in the specific embodiment without departing from the spirit or scope of the invention as broadly described. The present embodiment is, therefore, to be considered in all respects to be illustrative and not restrictive.

1. A vehicle booking processing system, comprising:
a locator process arranged to obtain location of a vehicle for hire, and
an order process arranged to receive a booking order from a customer device, and provide a request for acceptance of the booking to a vehicle device of a located vehicle,
wherein the order process is arranged to receive bid data from the customer device, the bid data representing an amount of additional credit that a user will pay in addition to a vehicle fare, and wherein the order process is arranged to receive condition data, the condition data providing a condition associated with the vehicle trip, the condition being required to be satisfied in order for the additional credit to be paid.

2. A system in accordance with claim 1, the locator process further being arranged to obtain location of the customer device.

3. A system in accordance with claim 2, further comprising:
a payment process arranged to provide a customer device with the identity of a vehicle associated with a located vehicle device within a predetermined proximity of the customer device, and to enable payment via the customer device for a trip in the vehicle.

4. A system in accordance with claim 2, further comprising:
a payment process arranged to provide a vehicle device with the identity of a customer associated with a located customer device within a predetermined proximity of the vehicle device, and to enable payment via the vehicle device for a trip in the vehicle associated with the vehicle device.

5. A system in accordance with claim 1, wherein the locator process is arranged to obtain the location vehicles in the vicinity of the customer device and provide location data of the vehicles to the customer so the customer may determine the vehicles within the vicinity of the customer device.

6. A vehicle booking and payment processing system, comprising:
a locator process arranged to obtain location of a customer device and location of a vehicle device associated with a vehicle, and to enable payment for a customer trip in the vehicle, payment being enabled by the locator process determining the customer device and vehicle device are within a predetermined proximity and by the payment process providing the customer device or vehicle device with identity of the respective vehicle device or customer device, respectively, so that payment can be made by selection by one of the customer device or vehicle device.

7. A method of booking a vehicle, comprising:
receiving a booking order from a customer,
providing a request for acceptance of the booking order to a vehicle,
receiving bid data from a customer, the bid data representing an amount of additional credit that a user will pay in addition to a vehicle fare, and receiving condition data, the condition data providing a condition associated with a vehicle trip, the condition being required to be satisfied in order for the additional credit to be paid.

8. A method in accordance with claim 7, further comprising:
obtaining location of vehicles in the vicinity of the customer, and
providing location information of the vehicles to the customer so the customer may determine the vehicles in their vicinity.

9. A method of booking and paying for a vehicle trip, comprising:
obtaining location of a customer and location of a vehicle, and
enabling payment for the customer trip by determining that the customer and vehicle are within a predetermined proximity and providing the customer or vehicle with the identity of the respective vehicle or customer, whereby the customer or vehicle may be selected for payment.

10. A vehicle booking processing system, comprising:
an order process arranged to receive a booking order from a customer device, and provide a request for acceptance of the booking to a vehicle device of a vehicle for hire,
wherein the order process is arranged to receive bid data from the customer device, the bid data representing an amount of additional credit that a user will pay in addition to a vehicle fare.

11. A system in accordance with claim 10, further comprising:
a locator process arranged to obtain location of vehicles in the vicinity of the customer device and to provide location data of the vehicles to the customer device, whereby the customer may determine the number of vehicles in their vicinity.
